(19) United States
(12) Patent Application Publication
(10) Pub. No.: US 2015/0155736 A1
(43) Pub. Date: Jun. 4, 2015

(54) Method and Apparatus for Extending Service Life of a Battery Source

(71) Applicants: Ying Sun, West Warwick, RI (US); Alexander Cheng, Scarsdale, NY (US)

(72) Inventors: Ying Sun, West Warwick, RI (US); Alexander Cheng, Scarsdale, NY (US)

(21) Appl. No.: 14/093,416

(22) Filed: Nov. 30, 2013

(51) Int. Cl. H02J 7/00

(52) U.S. Cl. CPC H02J 7/0063; H02J 7/0052; H02J 7/0047; H02J 2007/005

(57) ABSTRACT

A method and an apparatus are disclosed for extending the service life of a battery source by fully utilizing the energy in batteries and/or providing higher energy reserve using multiple batteries. The invention has economical and environmental benefits by reducing waste in batteries in addition to offering convenience and ease of maintenance in battery use. It also benefits the design of devices when replacing batteries is either difficult or impossible. A universal battery bank consists of an ensemble of possibly heterogeneous batteries all connected in series to provide a usable operational energy source. To exploit this power supply that may vary over a wide voltage range, electronics are designed to monitor the individual batteries, guard against excessive voltage and current, and provide constant current sources and/or constant voltage sources for various appliances.

### BACKGROUND OF THE INVENTION

Every year 15 billion batteries are sold worldwide. Many of them are primary batteries such as alkaline or zinc-carbon batteries, which are discarded after a single use. Batteries contain hazardous substances such as sulfuric acid, mercury, lead, cadmium, and other heavy metals, which need to be properly recycled before disposal. Used batteries often end up in landfill sites, posing a threat to the environment. Rechargeable batteries can alleviate the problem, but only to a limited extent. A rechargeable battery can provide good service for the first three years and usually needs to be disposed of after five years.

Almost all electronic devices are designed to operate with a fairly constant voltage supply. As the battery discharges, its output voltage decreases. A typical electronic device stops working properly when the supply voltage is below a certain threshold. For example, a quartz wall clock runs on a 1.5-volt AA battery and usually stops working when the battery is down to 1.2 V. However, for a 1.5 V alkaline battery it still possesses about 60% of its energy at 1.2 V, representing a significant waste. Even at the half-voltage point (0.75V)—often considered as the cutoff point—the battery still retains about 30% of its energy. Another example of under-utilization of the battery energy is the battery-operated smoke alarm. It is recommended that the battery in the alarm be replaced regularly as a safety precaution. It is not uncommon to find batteries in the recycle bin with a residual voltage in the 1.3-1.4 V range.

The residual energy in used batteries not only is wasteful but also can become a safety hazard. For example, excessive heat is generated when metallic lithium in a lithium battery is exposed to moisture. In the landfill, a lithium battery in a charged state could cause a fire when crushed by heavy equipment operating on the site. Landfill fires are notoriously persistent and can burn for years underground.

### DESCRIPTION OF THE RELATED ART

There have been constant endeavors throughout human history to improve on energy efficiency. These endeavors focus mostly on the usage side, i.e., to use less energy for a given task. Meanwhile most people are oblivious to the waste of energy in batteries although it becomes obvious once pointed out. Even for rechargeable batteries with so many improvements over the years, the loss over time (self-discharge) as another source of waste, albeit at a smaller scale than the residual energy addressed in this present patent, has rarely been considered.

Battery technology is a fervent area of research and development. It is highly desirable to have the increased capacity, higher density, and easier portability as features of an energy storage device. Currently with the popularity of portable electronics, such as cellphones, MP3 players, tablets and wearable computers, the market demands have prompted efforts to come up with technological solutions. These solutions, e.g. cellphone charger, use mostly fixed configuration of specialized batteries. In contrast, one embodiment of the present invention provides for an open architecture with flexibility using commodity-grade off-the-shelf batteries.

Over the years, they have been numerous advancements in battery technologies but none of these solutions address the problems addressed in this patent application.

### SUMMARY OF THE INVENTION

This invention provides a method and apparatus for extending the service life span of a battery source. This objective is achieved by fully utilizing the energy in batteries and/or providing higher energy reserve using multiple batteries. Furthermore, this invention can help utilize the residual energy left in used batteries. After their original services to charge an electronic device, the used batteries are further exploited to function until they are drained almost completely. By extending the service life of batteries this invention has a positive impact on the economy and environment. This is accomplished by stacking up many used batteries, either solely with other used batteries or with some new batteries, to provide a higher operational voltage. However, a technical difficulty arises because this operational voltage can vary over a wide range depending on the number of batteries included and the residual voltages of these batteries. The present invention discloses a method to overcome this technical difficulty.

The invention reveals the design of the Universal Battery Bank (UBB). In one embodiment, the UBB may be an ensemble of possibly heterogeneous batteries all connected in series. In another embodiment, the UBB may be an ensemble of similar battery types. A UBB may contain AA, AAA, AAAA, 9 V, C, D, button batteries, or any other types of primary or rechargeable batteries. Without the present invention, the output voltage of a collection of batteries in such arrangement is the sum of all the voltages of the batteries, which may vary over a relatively wide range. In one embodiment, the batteries connected in series are all of the type that have previously been used for charging. In another embodiment, the batteries connected in series consist of both used and new batteries. The UBB may contain a smart battery management unit (SBMU) that identifies low-voltage batteries to be replaced. The SBMU also indicates an over voltage situation when the output voltage is over a certain threshold because of too many high voltage batteries included in the UBB.

The energy in the UBB is exploited by using electronic circuitries that provide either constant voltage sources or constant current sources. The design of these circuits needs to take in consideration the need for handling a supply voltage that varies over a wide range. Protection circuitries are needed to prevent possible damages due to excessive voltage or excessive current. The constant voltage and current sources powered by a UBB can be used for a variety of appliances. The field of use includes LED lamps, flash lights, night lights, decorative lights, door bells, small electric fans, speakers, surveillance cameras, security sensors, smoke alarms, wearable devices, consumer electronics, and chargers for various portable devices.

The aforementioned concept of the UBB can be extended to the design of battery-powered devices when replacing batteries is either difficult or impossible. Such applications can be found in several fields of use such as implantable medical devices and remote-sensing probes. Generally speaking, any electronic device has a required minimum supply voltage to operate. For example, this minimum operational voltage may be Vₘᵢₙ. The battery voltage V_{b} needs to be higher than or equal to Vₘᵢₙ in order to maintain the function of the device. Thus, the operational range for the battery to discharge is V_{b}-Vₘᵢₙ. If we power this device with N batteries in series, this discharge range is extended to N V_{b}-Vₘᵢₙ. Not only does the capacity of the battery source increase by N times but also each individual battery can be discharged further to Vₘᵢₙ/N on average. Thus, this method of using multiple redundant batteries in series provides a means of extending the time interval between battery replacements and draining the individual batteries more efficiently.

### BRIEF DESCRIPTION OF THE DRAWING

The following description may be further understood with reference to the accompanying drawings in which:

FIG. 1 is an illustrative diagrammatic view of the system that utilizes the residual energy in used batteries.

FIG. 2 shows an example of the organization of the Universal Battery Bank (UBB).

FIG. 3 shows an example of the discharge characteristics of an alkaline AA battery (A) and the computed percent energy left in the battery as a function of the voltage (B).

FIG. 4 shows an example of the design of the Universal Battery Bank (UBB).

FIG. 5 shows three types of battery spacers: (A) jumper for providing a short-circuit, (B) connector leading to an external battery, and (C) carrier for holding smaller-size batteries.

FIG. 6 shows the organization of the Smart Battery Management Unit.

FIG. 7 shows the schematic diagram of one possible embodiment of the invention that provides LED illumination and output of constant voltages.

### DETAILED DESCRIPTION OF PREFERRED EMBODIMENT

The present invention discloses a system for utilizing the residual energy in used batteries. The Universal Battery Bank (UBB) collects a plurality of batteries which may be of various sizes and types, and which are all connected in series to provide a variable voltage source. The UBB contains a smart battery management unit that identifies the weak batteries with too low a voltage and detects an over voltage situation. The output of the UBB is used to provide constant current sources and/or constant voltage sources for powering various electronic and electrical appliances. By combining multiple used batteries the system can also be used for extending the usage of the batteries until they are drained almost completely.

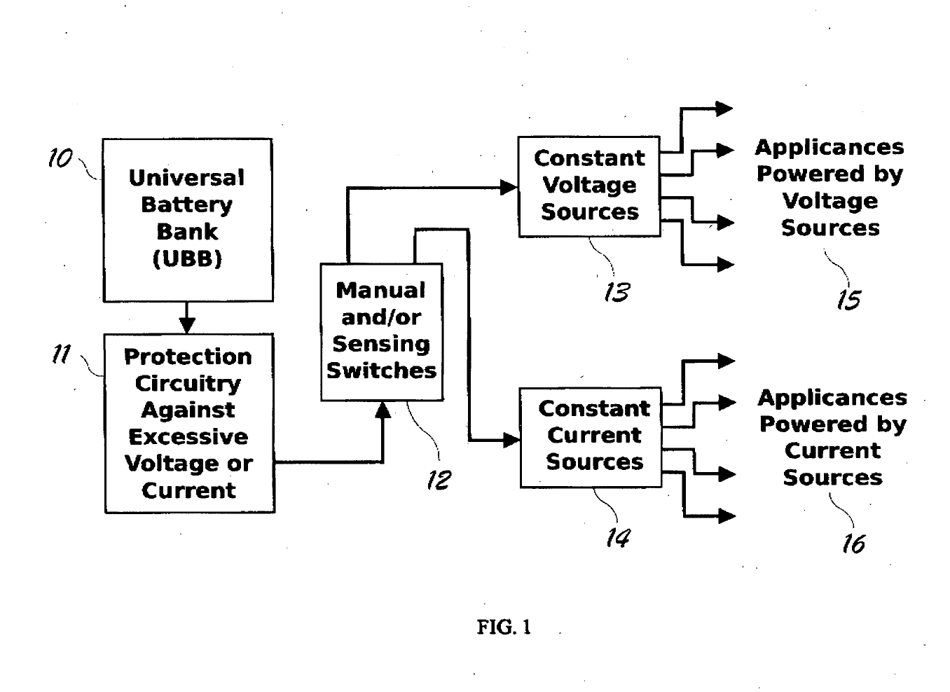

FIG. 1 shows the block diagram of the system that consists of Universal Battery Bank (UBB) 10, protection circuit guarding against excessive voltage or current 11, manual and/or sensing switches 12, constant voltage sources 13, and constant current sources 14. The output voltage of the UBB 10 can vary over a relatively wide range depending on how many batteries are included and the residual voltages of the individual batteries. One of skill in the art will understand that the protection circuit 11 is designed to prevent damage to the rest of the circuits due to excess voltage or current. The system can be turned on or off by a manual switch. An alternative is to turn the system on or off automatically either based on a sensing switch such as a light sensor, a motion sensor, an infrared sensor, a timer, or a combination of said sensors. The variable output voltage from UBB is regulated to either constant voltage sources 13 or constant current sources 14. Appliances powered by constant voltage source 15 include most consumer electronic devices and chargers for cellphones and tablets. Appliances powered by constant current source 16 include LED lamps, night lights and flash lights.

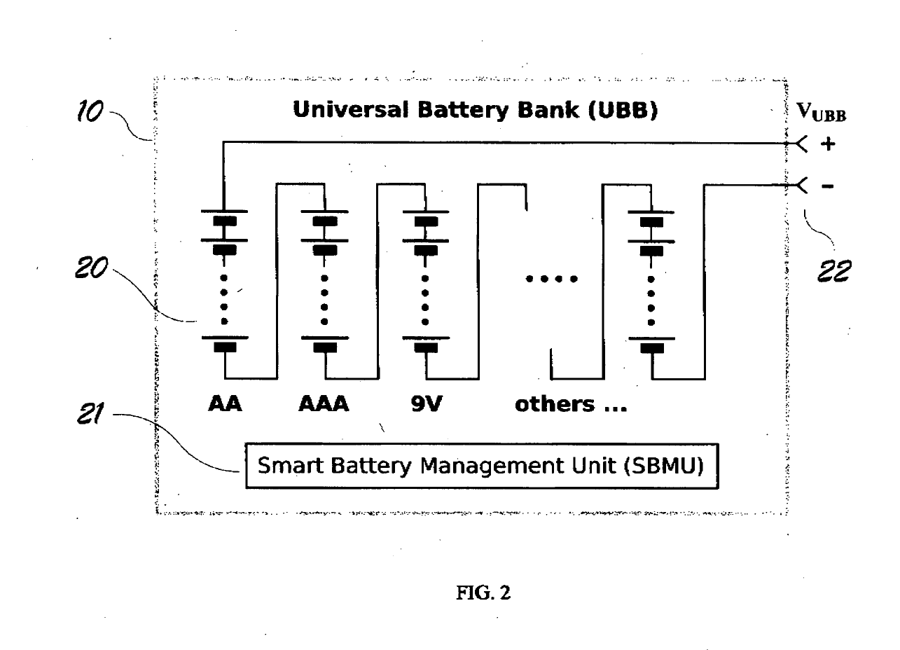

FIG. 2 shows the organization of the Universal Battery Bank (UBB) 10, which contains an ensemble of heterogeneous batteries such as D, C, AA, AAA, 9V, and button batteries 20. In another embodiment, the batteries in the UBB are all of the same type. When multiple batteries are contained in the UBB, the batteries are preferably connected in series. A smart battery management unit 21 monitors the voltages of the individual battery or batteries and detects an over voltage situation when the output voltage 22 is beyond a certain threshold. The output voltage is the sum of all the residual voltages of the individual batteries.

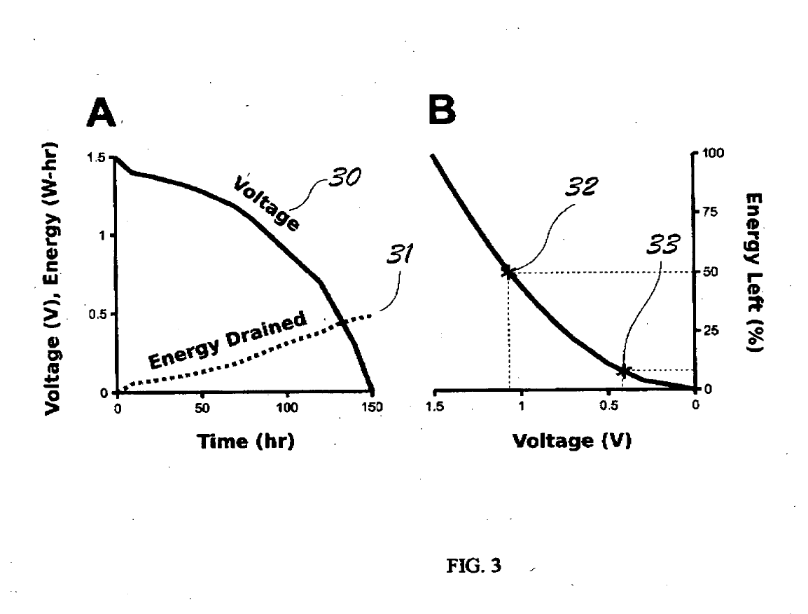

The smart battery management unit 21 uses the discharge characteristics of the individual batteries to determine when the batteries are sufficiently drained and should be removed. FIG. 3A shows an example of discharging a 1.5-V AA battery via a constant resistance R of 47Ω. The discharge characteristic curve 30 shows the battery voltage V(t) as a function of time. The energy drained E(t) 31 as a function of time is computed as follows:

E(t)=∫₀^{t}v²(T)/Rdτ (1)

FIG. 3B shows the percent energy left in the battery (1−E)/Eₘₐₓ, as a function of the battery voltage V, where Eₘₐₓ is the maximum energy drained from the battery. This computed curve provides useful information to manage a used battery. For example, the half-energy point 32 is at 1.1 V. A reasonable point to discard the battery is 10% energy left 33, when the battery voltage is down to 0.4 V. While it is possible to drain the battery energy completely, the internal resistance may rise near complete discharge. A high internal battery resistance is not desirable because it impedes the current flow. However, complete discharge may be possible under proper conditions.

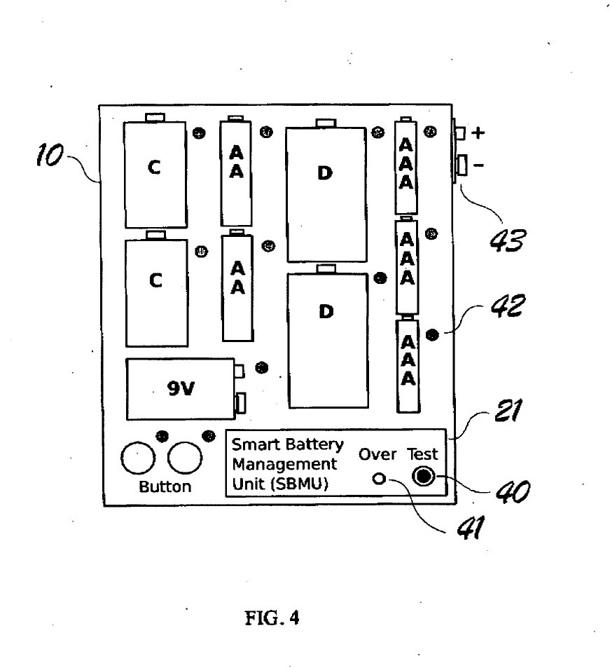

FIG. 4 shows one of the possible embodiments of the Universal Battery Bank (UBB) 10. The smart battery management unit (SBMU) 21 is activated by pushing the test button 40 or may be activated using alternative techniques as is known by those of skill in the art. If the total output voltage is over a preset threshold, the over-voltage indicator 41 lights up or another indicator provides a notification. Each battery is associated with a low-voltage indicator 42. If the battery voltage is below a preset threshold, the low-voltage indicator lights up or another type of indicator provides a notification. The total output voltage is connected to a battery clip 43, which can be plugged into the rest of the system. This particular configuration contains a 9V battery, three AAA batteries, and two for each of the D, C, AA, and button batteries. The maximum output voltage is 25.5 V when all the batteries are at their maximum capacity.

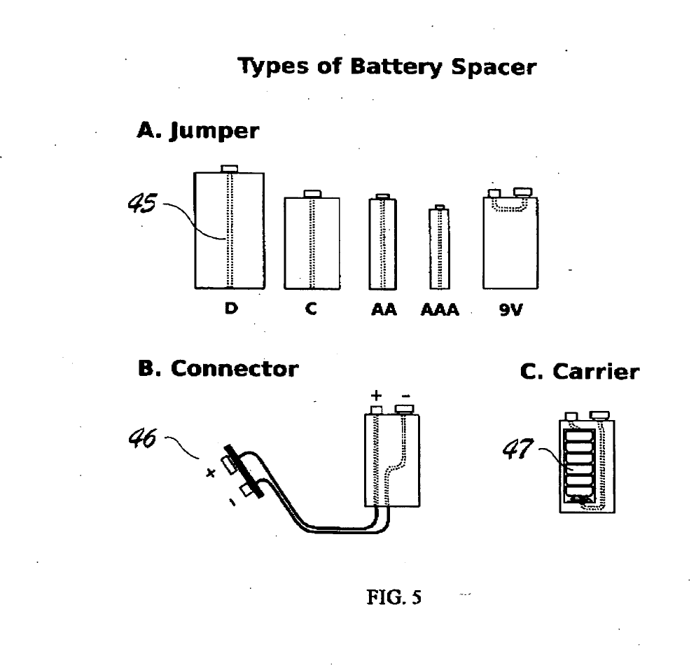

FIG. 5 shows an embodiment of three types of battery spacers as accessories for the UBB system. A battery spacer has the same physical shape of a standard battery type, but is not a real battery. The battery spacer may take on different shapes depending on the various battery types. FIG. 5A show the jumper spacer, which has a conducting wire 45 to short the positive terminal and negative terminal. The UBB has fixed spaces for specific types of batteries. Because all batteries are preferably connected in series, it is required that all spaces are filled in order to complete the circuit. In case there is no battery available for a space, the space can be filled with a jumper spacer. FIG. 5B shows the connector spacer, which is to be inserted into the battery compartment of an appliance and provides an external connector 46 for the UBB. Thus, via a connector spacer the UBB can serve as a replacement for an ordinary battery in an appliance. FIG. 5C shows the carrier spacer, which serves as a holder for small-sized batteries. For example, six button batteries 47 can be loaded into a carrier spacer that has the shape of a 9V battery.

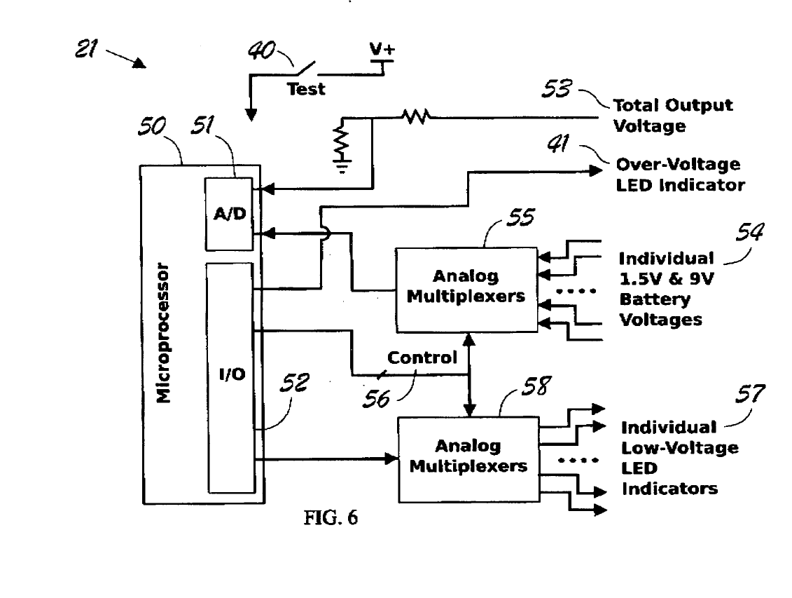

FIG. 6 shows one embodiment of the smart battery management unit (SBMU) 21. The SBMU contains a microprocessor 50 that has a multi-channel analog-to-digital converter (A/D) 51 and input-output ports (I/O) 52. The SBMU is operational when the test button 40 is pushed to supply the power or other technique to turn on power as would be known to those skilled in the art. The total output voltage 53 is inputted to the A/D via a voltage divider. The over-voltage LED indicator 54 is lit up when the output voltage 41 is over a preset threshold. The voltages of the individual batteries 54 are examined by the microprocessor via the analog multiplexers 55. The batteries are sequentially selected by use of the control lines 56. If a low-voltage situation is detected for a battery, the corresponding low-voltage LED indicator 57 is lit via other analog multiplexers 58, which are selected by the same control lines 56. The microprocessor 50 repeatedly and sequentially scans through all the batteries at varying or predetermined frequencies.

The SBMU can also be programmed to check the internal resistance of a battery, which can be done by comparing the battery voltages with or without a load connected to the UBB as follows. Let the output voltage 53 be V_{UBB} when a load of resistance R_{LOAD} is connected to the output port of the UBB. Let the voltage of a specific battery be: Vₙ without load (the output of the UBB is an open circuit); Vₙ′ with load. The internal resistance of the battery Rₙ is given by:

Rₙ=R_{load}(Vₙ′−Vₙ)/V_{UBB}

The SBMU can light up the corresponding low-voltage LED indicator 57 if Rₙ is above a preset threshold, or when Vₙ′ is larger than Vₙ beyond a preset percentage. Other techniques to provide an indicator are possible.

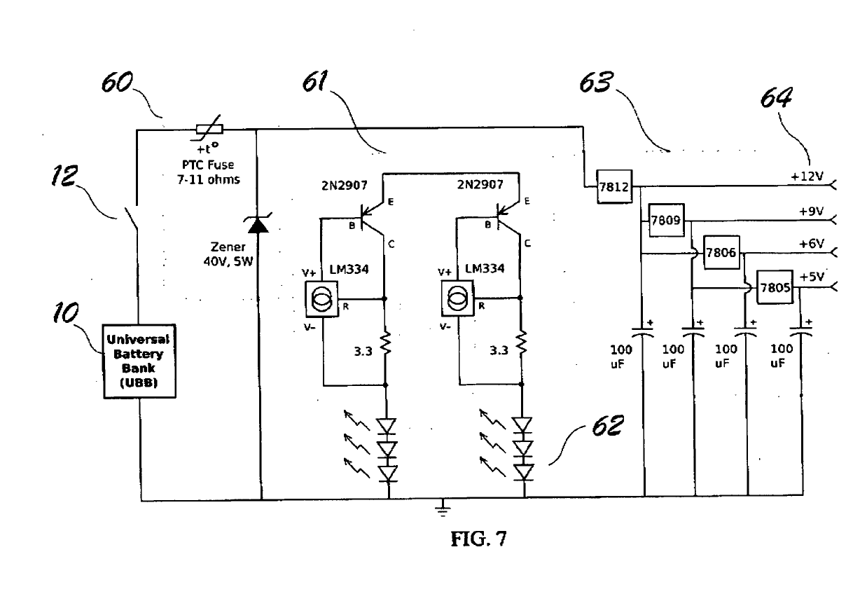

FIG. 7 shows the schematic diagram of a possible embodiment of the invention. The UBB 10 provides power to the system in one embodiment via a manual switch 12. Because the output voltage of the UBB is a variable, a voltage protection circuit 60 ensures that the supply voltage does not exceed a certain limit. In one embodiment, this may be accomplished by a positive-thermal-coefficient (PTC) fuse and a zener diode. An excessive voltage would result in currents flowing through the zener diode. Excessive currents would trigger an increase of the resistance of the PTC fuse, which serves as a current limiter and prevents the zener diode from burning out. For a given application one of skill in the art would understand that a PTC fuse with the appropriate trigger current and power rating can be chosen, as described in “POSISTOR® for Circuit Protection,” Cat. No. R90E-13, Murata Manufacturing Co., Sep. 24, 2012.

The constant current source circuit 61 consists of two branches, each of which provides a current of 20 mA to light up 3 LED's 62. While many different designs of constant current sources are available, one of skill in the art would understand that the design herein can operate with a relatively wide voltage range by using an off-the-shelf integrated circuit LM334, as described in “LM134/LM234/LM334 3-Terminal Adjustable Current Sources.” Texas Instruments, SNVS746F, March 2000, revised May, 2013.

The constant voltage source circuit 63 consists of a cascade of voltage regulators that provide 12V, 9V, 6V and 5V sources to external devices. The cascade design can handle a high supply voltage source by stepping down the voltages with a series of voltage regulators of different output voltages. One of skill in the art would understand that the voltage regulator integrated circuits are also off-the-shelf, such as MC78L00A Series, NCV78L00A 100 mA Positive Voltage Regulators, On Semiconductors, Publication Order Number: MC78L00A/D, Rev. 15, Jan. 2010.

The extended service life of a battery source enabled by the present invention can be quite substantial. A quick calculation follows approximating linear discharge characteristics. If we use a common value of 70% of energy left in a battery when it is replaced and discarded at the end of one year of service. This present invention can offer up to (100%−10%)/30%=3 years of service. With 2 batteries of the same type, we can expect to double the service life of the battery source to 6 years. With 3 batteries, the result is 9 years, and so on.

Some of the components described above are not absolutely required for certain embodiments of the present invention. For example, the SBMU can be eliminated. Low-voltage batteries can be identified by manual checking with a multimeter or a battery tester. The over-voltage situation can be avoided by including a limited number of battery spaces in the UBB. The protection circuit can also be eliminated if the maximum output voltage of the UBB is within a safe range. A universal design may call for the co-existence of both the constant voltage sources and the constant current sources. However, the system likely requires only one type of source if the application is very specific. Those skilled in the art will appreciate that numerous modifications and variations may be made to the above disclosed embodiments without departing from the spirit and scope of the inventions.

What is claimed is:

1. A method of extending service life of a battery source comprising the steps of
a) providing a battery bank comprising one or more batteries connected in series,
b) regulating output voltage of said battery bank, and
c) providing an indication of the status of the battery bank.

2. A method of extending service life of a battery source comprising the steps of
a) providing a battery bank comprising one or more batteries connected in series,
b) regulating output current of said battery bank, and
c) providing an indication of the status of the battery bank.

3. In the method of extending service life of a battery source according to claim 1, said step of providing a battery bank further comprises providing a battery spacer with a jumper between positive and negative terminals.

4. In the method of extending service life of a battery source according to claim 1, said step of providing a battery bank further comprises providing a battery connector.

5. In the method of extending service life of a battery source according to claim 1, said step of providing a battery bank further comprises providing a carrier spacer for holding one or more smaller sized batteries.

6. In the method of extending service life of a battery source according to claim 1, said step of regulating output voltage of said battery bank further provides cutting off output voltage when voltage level reaches a predetermined threshold comprising the use of a voltage protection circuit.

7. In the method of extending service lire of a battery source according to claim 2, said step of regulating output current of said battery bank further provides cutting off output current when current level reaches a predetermined threshold comprising the use of a current protection circuit.

8. In the method of extending service life of a battery source according to claim 2, said step of providing a battery bank further comprises providing a battery spacer with a jumper between positive and negative terminals.

9. In the method of extending service life of a battery source according to claim 2, said step of providing a battery bank further comprises providing a battery connector.

10. In the method of extending service life of a battery source according to claim 2, said step of providing a battery bank further comprises providing a battery holder of one or more smaller sized batteries.

11. In the method of extending service life of a battery source according to claim 1, further comprises calculating and setting a predetermined threshold by:
(a) monitoring discharge characteristics of said one or more batteries,
(b) comparing said discharge characteristics to a preset value, and
(c) setting said predetermined threshold.

12. In the method of extending service life of a battery source according to claim 2, further comprising calculating and setting a predetermined threshold by:
(a) monitoring discharge characteristics of said one or more batteries,
(b) comparing said discharge characteristics to a preset value, and
(c) setting said predetermined threshold.

13. An apparatus for extending service life of a battery source comprising:
(a) a battery bank comprising one or more batteries connected in series;
(b) electronic circuitry to provide constant voltage source, and
(c) an indication of the status of the battery bank.

14. An apparatus for extending service life of a battery source comprising:
(a) a battery bank comprising one or more batteries connected in series;
(b) electronic circuitry to provide constant current source, and
(c) an indication of the status of the battery bank.

15. In the apparatus for extending service life of a battery source according to claim 13, said battery bank further comprises a battery spacer with a jumper between positive and negative terminals.

16. In the apparatus of extending service life of a battery source according to claim 13, said battery bank further comprises a battery connector.

17. In the apparatus of extending service life of a battery source according to claim 13, said battery bank further comprises a carrier spacer for holding smaller sized battery.

18. In the apparatus of extending service life of a battery source according to claim 13, said battery bank further comprises a voltage protection circuit to regulate output voltage of said battery bank by cutting off output voltage when voltage level reaches a predetermined threshold.

19. In the apparatus of extending service life of a battery source according to claim 13, further comprises circuitry to calculate and set a predetermined threshold by:
(a) monitoring discharge characteristics of said one or more batteries,
(b) comparing said discharge characteristics to a preset value, and
(c) setting said predetermined threshold.

20. In the apparatus of extending service life of a battery source according to claim 14, said battery bank further comprises circuitry current protection circuit to regulate output current of said battery bank by cutting off output current when current level reaches a predetermined threshold.
